(19) United States
(12) Patent Application Publication
(10) Pub. No.: US 2025/0161153 A1
(43) Pub. Date: May 22, 2025

(54) HAMMERING MECHANISM WITH HAMMERING AND CLAMPING FUNCTIONS AND NECK MASSAGE DEVICE HAVING THE SAME

(71) Applicant: THE PERFECT HEALTH SCIENCE&TECHNOLOGY DEVELOPMENT CO.LTD, Shenzhen (CN)

(72) Inventors: Xiangping WU, Shenzhen (CN); Xue LIU, Shenzhen (CN); Yuanfu NING, Shenzhen (CN)

(73) Assignee: THE PERFECT HEALTH SCIENCE&TECHNOLOGY DEVELOPMENT CO.LTD, Shenzhen (CN)

(21) Appl. No.: 18/513,725

(22) Filed: Nov. 20, 2023

(30) Foreign Application Priority Data
Sep. 19, 2022 (CN) 202211135692.1

(51) Int. Cl. A61H 23/00; A61H 23/02; B06B 1/12

(52) U.S. Cl. CPC A61H 23/006; A61H 23/0263; B06B 1/12; A61H 2201/149; A61H 2201/1664; A61H 2205/04; B06B 2201/76

(57) ABSTRACT

A hammering mechanism with hammering and clamping functions and a neck massage device having the same are provided. The hammering mechanism includes a driving assembly, a hammer arm assembly, a first transmission assembly for converting the rotational motion generated by the driving assembly into a piston motion, and a second transmission assembly for transmitting the rotational motion generated by the driving assembly to the hammer arm assembly. The first transmission assembly and the second transmission assembly are in transmission connection with the driving assembly, and the first transmission assembly and the second transmission assembly are in transmission connection with the hammer arm assembly. When the hammer arm assembly entirely performs a reciprocating motion within an arc area, a hammering effect is achieved, and when the hammer arm assembly reciprocates back and forth within an area of each sub-central angle, a clamping effect is achieved.

### CROSS REFERENCE TO THE RELATED APPLICATIONS

This application is based upon and claims priority to Chinese Patent Application No. 202211135692.1, filed on Sep. 19, 2022, the entire contents of which are incorporated herein by reference.

### TECHNICAL FIELD

This invention generally relates to the technical field of massage devices, and more particularly, to a hammering mechanism with hammering and clamping functions and a neck massage device having the same.

### BACKGROUND

More and more people suffer from shoulder and neck pain due to long-term sitting. To provide relief of pain, massage devices are used to massage the area of pain for relieving a headache or muscle stiffness, thereby achieving effects of relaxing the body and mood, soothing nerves, promoting blood circulation and relieving fatigue.

In the prior art, conventional massage devices normally adopt a motor to propel a massage head to rotate. Taking a neck massage device as an example, the neck massage device is sleeved on a user's neck, and the massage head merely rotates in a corresponding area to achieve a kneading massage effect.

Chinese patent CN114533507A discloses a neck massage device with kneading and knocking functions. The knocking massage mechanism of the neck massage device merely performs a reciprocating arc motion in a large area to realize a knocking massage function instead of a clamping massage function. Therefore, the relaxation effect of the neck massage device on a user's shoulder and neck is not ideal.

Thus, it is urgent for those skilled in the art to provide a hammering mechanism with hammering and clamping functions and a neck massage device having the same.

### SUMMARY

The purpose of the present invention is to provide a hammering mechanism with hammering and clamping functions, which is capable of achieving hammering and clamping effects.

To achieve the above purpose, the present invention adopts the following technical solution: a hammering mechanism with hammering and clamping functions includes a driving assembly, a hammer arm assembly, a first transmission assembly for converting the rotational motion generated by the driving assembly into a piston motion, and a second transmission assembly for transmitting the rotational motion generated by the driving assembly to the hammer arm assembly, wherein both the first transmission assembly and the second transmission assembly are in transmission connection with the driving assembly, and both the first transmission assembly and the second transmission assembly are in transmission connection with the hammer arm assembly, wherein when the first transmission assembly operates individually, the hammer arm assembly performs a reciprocating arc motion, wherein the central angle of the arc is defined as the total central angle, wherein the total central angle is divided into a plurality of sub-central angles, wherein when the first transmission assembly and the second transmission assembly operate together, the hammer arm assembly sequentially passes through the areas of the plurality of sub-central angles and reciprocates in the area of each sub-central angle.

In another preferred embodiment of the present invention, the second transmission assembly includes a rotating rod, a spring and a belt pulley. The belt pulley is rotatably assembled on an outer surface of the rotating rod. One end of the spring is fixedly connected to the belt pulley, and the other end of the spring is fixedly connected to the rotating rod. The rotating rod is in transmission assembly with the hammer arm assembly. The hammer arm assembly includes a hammer head, an arm body, a fixing member and an eccentric wheel. The hammer head and the fixing member are respectively fixedly assembled at two ends of the arm body, the eccentric wheel is fixedly assembled at a tail end of the rotating rod, and the arm body is movably assembled on the eccentric wheel. The first transmission assembly is movably assembled with the fixing member, and the driving assembly is assembled with the belt pulley in a transmission mode through a belt.

In another preferred embodiment of the present invention, the eccentric wheel is provided with a wheel body and an assembling end. The assembling end is eccentric relative to the rotating rod, and the arm body is movably assembled with the assembling end.

In another preferred embodiment of the present invention, the arm body and the eccentric wheel are movably assembled through the first bearing, and the center of the first bearing is the center of the arc.

In another preferred embodiment of the present invention, the first transmission assembly includes a first gear and a connecting rod portion, and the first gear is engaged with the driving assembly. One end of the connecting rod portion is assembled with the first gear, and the other end of the connecting rod portion is assembled with the hammer arm assembly. The first gear includes a gear body and an eccentric boss, wherein the eccentric boss is fixedly connected to one side of the gear body. The connecting rod portion includes a sleeve arm and a connecting arm. The gear body is engaged with the driving assembly. One end of the sleeve arm is sleeved on the periphery of the eccentric boss, and the other end of the sleeve arm is assembled with one end of the connecting arm. The ball head arranged on the other end of the connecting arm is rotatably assembled with the fixing member of the hammer arm assembly.

In another preferred embodiment of the present invention, the fixing member is provided with a spherical chamber, and the ball head is rotatably assembled inside the spherical chamber.

In another preferred embodiment of the present invention, the driving assembly of the present invention includes a motor and a duplex gear. A first rotating shaft of the motor is engaged with one layer of the duplex gear, a second rotating shaft of the motor is in transmission connection with a transmission belt, and the other layer of the duplex gear is engaged with a first gear. When the transmission belt propels a belt pulley to rotate, the belt pulley propels a spring to tighten. At this point, the second rotating shaft rotates forward, and meanwhile, the spring propels a rotating rod to rotate. The belt pulley is propelled by the transmission belt to rotate, and the belt pulley does not propel the spring to tighten. At this point, the second rotating shaft rotate reversely, and the rotating rod does not rotate along with the rotation of the transmission belt.

In another preferred embodiment of the present invention, a plurality of annular protrusions are arranged on an inner surface of the transmission belt, and the plurality of annular protrusions are distributed in parallel. The outer surface of the belt pulley is provided with a first annular groove for interacting with the annular protrusion. The annular protrusion is embedded in the first annular groove. An outer surface of the first rotating shaft is provided with threads for interacting with the first gear. An outer surface of the second rotating shaft is provided with a plurality of second annular grooves for interacting with the annular protrusions, and the annular protrusions are embedded in the second annular grooves.

In another preferred embodiment of the present invention, there are a plurality of first transmission assemblies, and there are a plurality of hammer arm assemblies. The number of the first transmission assemblies is the same as the number of the hammer arm assemblies, and the first transmission assemblies correspond to the hammer arm assemblies one by one. The first gears of the at least one first transmission assembly are engaged with the duplex gears. Each first transmission assembly is further provided with a second gear, the second gear is engaged with the first gear of the same first transmission assembly, and the second gear is further engaged with a second gear of an adjacent first transmission assembly.

The present invention also provides a neck massage device having the hammering mechanism with hammering and clamping functions.

The neck massage device further includes a shell and a rotating massage mechanism, wherein the rotating massage mechanism and the hammering mechanism with hammering and clamping functions are both assembled inside the shell, and the rotating massage mechanism is assembled on the first gear of the first transmission assembly.

Compared with the prior art, the present invention has the following advantages: the present invention provides a hammering mechanism with hammering and clamping functions and a neck massage device having the same; the hammering mechanism with hammering and clamping functions includes a driving assembly, a hammer arm assembly, a first transmission assembly for converting the rotational motion generated by the driving assembly into a piston motion, and a second transmission assembly for transmitting the rotational motion generated by the driving assembly to the hammer arm assembly; both the first transmission assembly and the second transmission assembly are in transmission connection with the driving assembly, and both the first transmission assembly and the second transmission assembly are in transmission connection with the hammer arm assembly; when the first transmission assembly operates individually, the hammer arm assembly performs a reciprocating arc motion; the central angle of the arc is defined as the total central angle, and the total central angle is divided into a plurality of sub-central angles; when the first transmission assembly and the second transmission assembly operate together, the hammer arm assembly sequentially passes through the areas of the plurality of sub-central angles and reciprocates in the area of each sub-central angle; under the combined action of the first transmission assembly and the second transmission assembly, when the hammer arm assembly entirely performs a reciprocating motion within an arc area, a hammering effect is achieved, and when the hammer arm assembly reciprocates back and forth within an area of each sub-central angle, back-and-forth reciprocating motion is performed at different angles; when the included angle between a user and the massage surface is small, a pressing effect on the user is achieved, greatly improving the massage effect.

### BRIEF DESCRIPTION OF THE DRAWINGS

The present invention is further explained using the drawings. The content in the drawings is used for an illustrative purpose and is not intended to limit the present invention.

FIG. 1 is a schematic diagram illustrating an exemplary structure of the hammering mechanism with hammering and clamping function;

FIG. 2 is a schematic diagram of FIG. 1 from another viewing angle;

FIG. 3 is a schematic diagram of FIG. 1 from another viewing angle;

FIG. 4 is a schematic diagram illustrating a moving path when the hammering mechanism performs a hammering function;

FIG. 5 is a schematic diagram illustrating a moving path when the hammering mechanism performs a clamping function;

FIG. 6 is a schematic diagram illustrating an exemplary structure of the driving assembly;

FIG. 7 is a schematic diagram illustrating an exemplary structure of the duplex gear;

FIG. 8 is a schematic diagram illustrating an exemplary structure of the first transmission assembly;

FIG. 9 is a schematic diagram illustrating an exemplary structure of the first gear;

FIG. 10 is a schematic diagram illustrating an exemplary structure of the connecting rod portion;

FIG. 11 is a schematic diagram illustrating an exemplary structure of the hammer arm assembly;

FIG. 12 is a schematic diagram illustrating an exemplary structure of the eccentric wheel;

FIG. 13 is a schematic diagram illustrating an exemplary structure of the second transmission assembly;

FIG. 14 is a schematic diagram illustrating an exemplary structure of the second transmission assembly and the hammer arm assembly;

FIG. 15 is a schematic diagram illustrating an exemplary structure of the hammering mechanism with hammering and clamping function in embodiment 2;

FIG. 16 is a schematic diagram illustrating an exemplary structure of the neck massage device in embodiment 3;

FIG. 17 is a schematic diagram illustrating an exemplary structure of FIG. 16 (the shell is not shown).

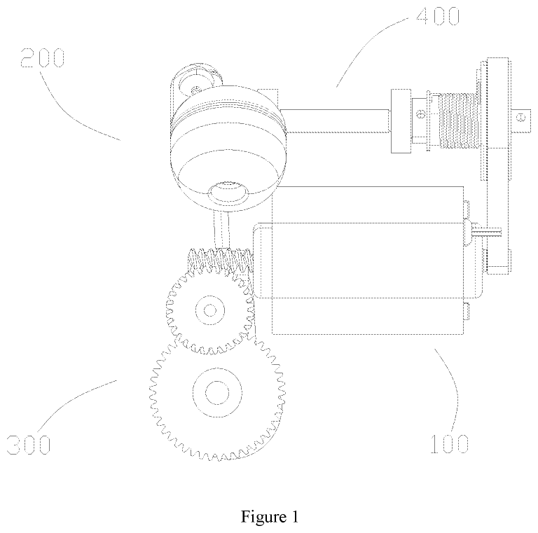

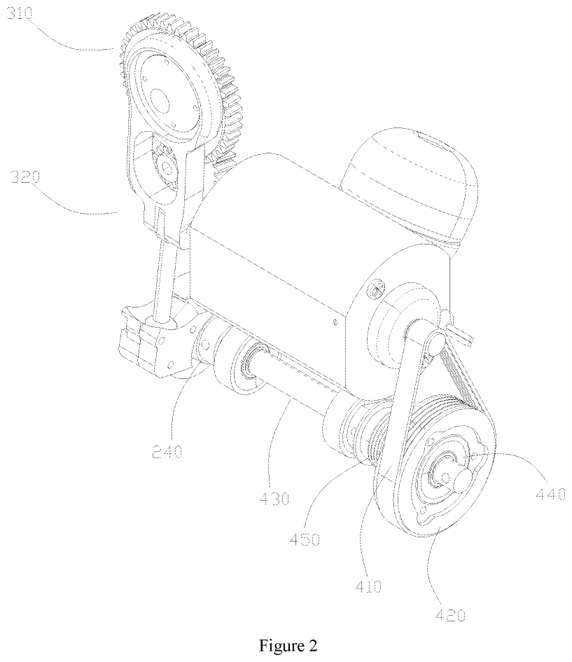

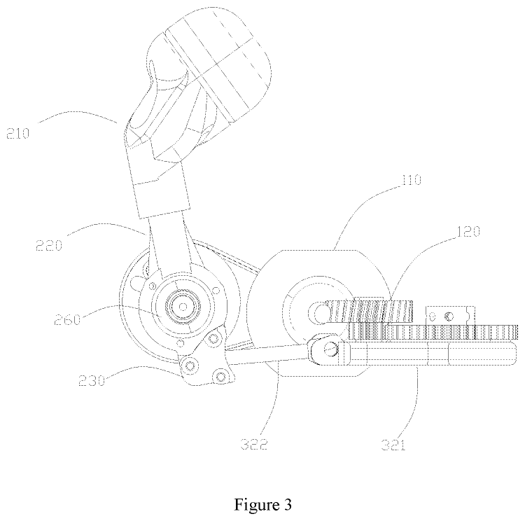

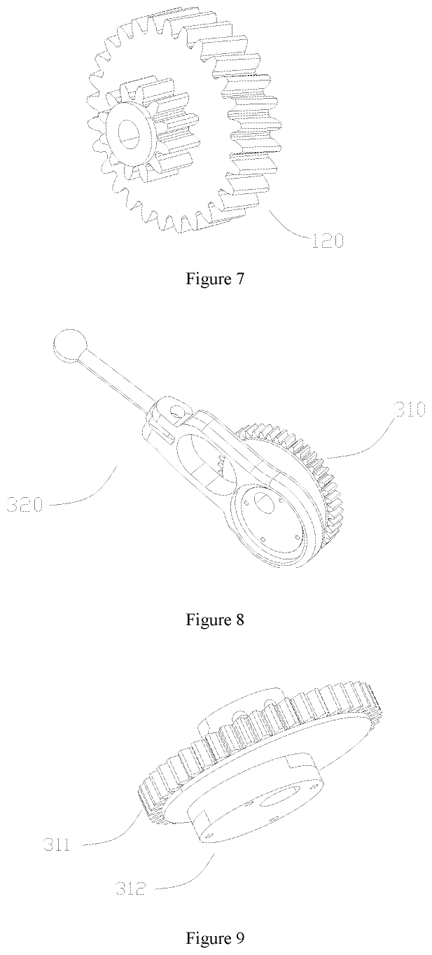

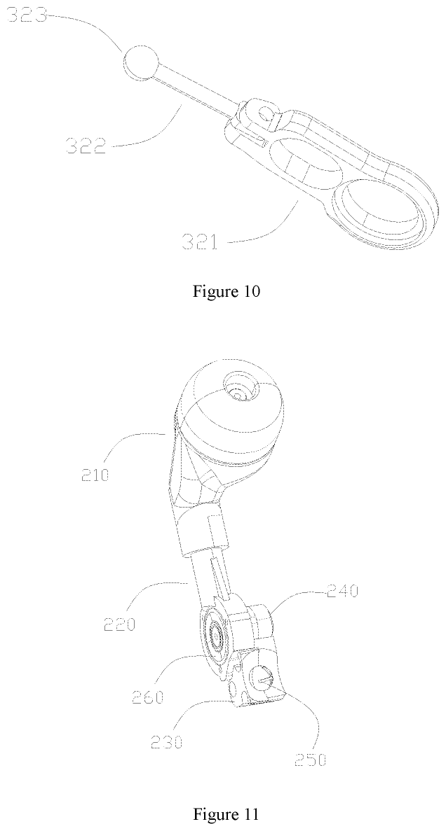

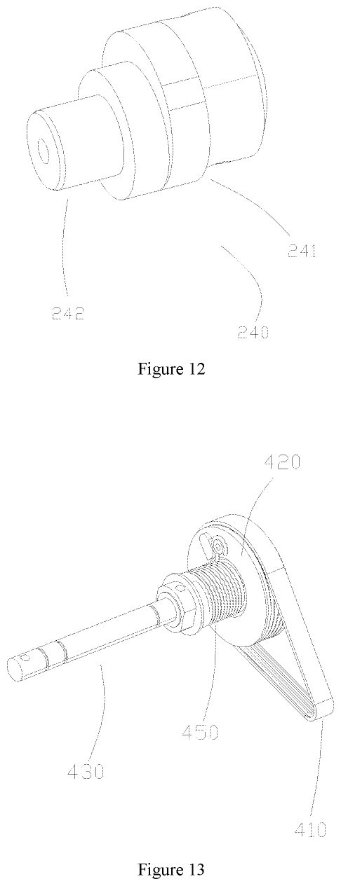

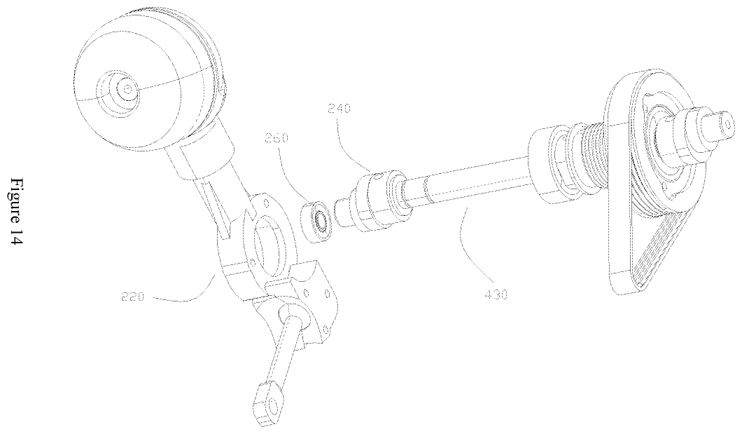

In FIGS. 1-17:
100—Driving Assembly, 110—Motor, 120—Duplex Gear, 130—The First Rotating Shaft, 140—The Second Rotating Shaft, 200—Hammer Arm Assembly, 210—Hammer Head, 220—Arm Body, 230—Fixing Member, 240—Eccentric Wheel, 241—Wheel Body, 242—Assembling End, 250—Sepherical Chamber, 260—The First Bearing, 300—The First Transmission Assembly, 310—The First Gear, 311—Gear Body, 312—Eccentric Boss, 320—Connecting Rod Portion, 321—Sleeve Arm, 322—Connecting Arm, 323—Ball Head, 330—The Second Gear, 400—The Second Transmission Assembly, 410—Transmission Belt, 420—Belt Pulley, 430—Rotating Rod, 440—The Second Bearing, 450—Spring, 500—Rotating Massage Mechanism, 600—Shell.

### DETAILED DESCRIPTION OF THE EMBODIMENTS

Detailed embodiments are combined hereinafter to further elaborate the technical solution of the present invention.

### Embodiment 1

As shown in FIGS. 1-14, the hammering mechanism with hammering and clamping functions of the present invention includes a driving assembly 100, a hammer arm assembly 200, a first transmission assembly 300 for converting the rotational motion generated by the driving assembly 100 into a piston motion, and a second transmission assembly 400 for transmitting the rotational motion generated by the driving assembly 100 to the hammer arm assembly 200. Both the first transmission assembly 300 and the second transmission assembly 400 are in transmission connection with the driving assembly 100, and both the first transmission assembly 300 and the second transmission assembly 400 are in transmission connection with the hammer arm assembly 200.

It is worth mentioning that, the hammering mechanism of the present invention may be assembled inside a seat body or a housing such as a mounting seat, which are briefly described herein.

When the first transmission assembly 300 operates individually, the hammer arm assembly 200 performs a reciprocating arc motion. It should be noted that, in the present invention, the reciprocating arc motion means a motion performed by a hammer head 200 reciprocating within a certain radian range by taking the center of a first bearing 260 in the hammer arm assembly 200 as the center of the hammer arm assembly 200 and the distance between the hammer head 210 and the center of the first bearing as a radius to form hammering and knocking effects.

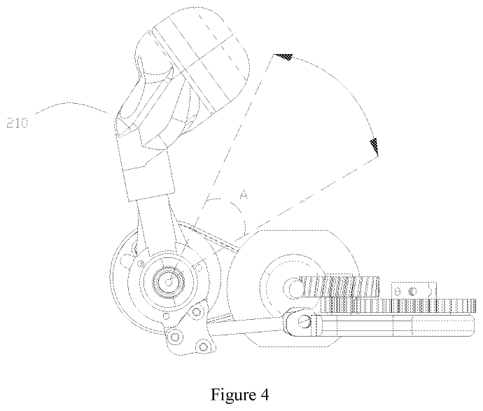

The central angle of the arc is defined as the total central angle, and as shown in FIG. 4, the hammer arm assembly 200 performs a reciprocating arc motion in an area where the central angle is defined as A. It should be noted that, under such circumstances, the hammer arm assembly 200 exhibits a hammering massage function.

The total central angle is divided into a plurality of sub-central angles. For example, as shown in FIG. 4, the total central angle is defined as A and the plurality of sub-central angles are respectively defined as B, C and D. When the first transmission assembly 300 and the second transmission assembly 400 operate together, the hammer arm assembly 200 sequentially passes through the areas of the plurality of sub-central angles and reciprocates in the area of each sub-central angle.

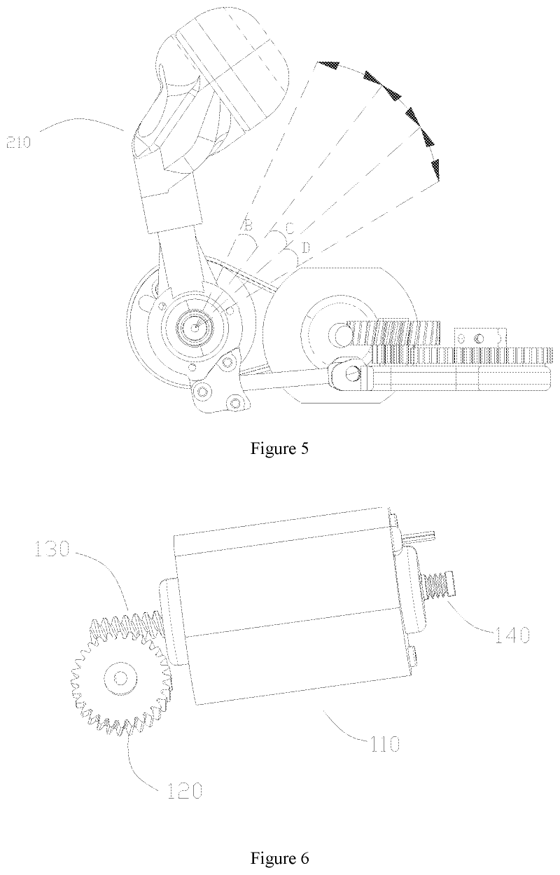

In this embodiment, as shown in FIG. 5, the hammer arm assembly 200 respectively performs a reciprocating arc motion in the areas of the sub-central angles B, C and D. Specifically, the hammer arm assembly 200 performs a reciprocating arc motion for a period of time in the area of the sub-central angle B, then the hammer arm assembly 200 enters the area of the sub-central angle C to perform a reciprocating arc motion for a period of time, and finally the hammer arm assembly 200 enters the area of the sub-central angle D to perform a reciprocating arc motion for a period of time.

It is worth mentioning that, in this process, when the hammering mechanism operates, the hammer arm assembly 200 sequentially passes through the areas of the plurality of sub-central angles, namely, performing the reciprocating motion at different angles. In this process, the hammer arm assembly 200 acts on a user to form squeezing and pushing effects, thereby forming the reciprocating arc motion at different angles. In areas of different sub-central angles, the squeezing force and squeezing effect on the user's skin also vary. Moreover, the hammer arm assembly 200 also forms a hammering effect during the reciprocating process. In the present invention, the hammering mechanism synchronously achieves the squeezing, pushing and hammering effects during use.

The driving assembly 100 of the present invention includes a motor 110 and a duplex gear 120. A first rotating shaft 130 of the motor 110 is engaged with one layer of the duplex gear 120, a second rotating shaft 140 of the motor 110 is in transmission connection with a transmission belt 410, and the other layer of the duplex gear 120 is engaged with a first gear 310.

The driving assembly 100 propels the first transmission assembly to move via the first rotating shaft 130, and the driving assembly 100 propels the second transmission assembly 400 to move via the second rotating shaft 140.

More specifically, the driving mode of the driving assembly 100 is as follows: when the transmission belt 410 propels a belt pulley 420 to rotate, the belt pulley 420 propels a spring 450 to tighten. At this point, the second rotating shaft 140 rotates forward, and meanwhile, the spring 450 propels a rotating rod 430 to rotate.

The belt pulley 420 is propelled by the transmission belt 410 to rotate, and the belt pulley 420 does not propel the spring 450 to tighten. At this point, the second rotating shaft 140 rotate reversely, and the rotating rod 430 does not rotate along with the rotation of the transmission belt 410.

It is worth mentioning that, when the second rotating shaft 140 rotates forward, the spring 450 tightens and propels the rotating rod 430 to rotate. The rotating rod 430 is connected to an eccentric wheel 240, and an arm body 220 generates a deflection acting force through an assembling end 242 of the eccentric wheel 240. The rotating rod 430 generates a push-and-pull acting force through the eccentric wheel 240, and the arm body 220 performs a clamping massage function by means of the deflection acting force and the pulling force.

When the second rotating shaft 140 rotates reversely, the transmission belt 410 propels the belt pulley 420 to rotate, and the belt pulley 420 propels the spring 450 to contract. At this point, the rotating rod 430 does not rotate, and the rotating rod 430 does not generate a deflection acting force on the eccentric wheel 240. The rotating rod 430 pulls the arm body 220 to perform a reciprocating knocking action at the assembling end 242, thereby achieving a hammering effect.

The first transmission assembly 300 includes a first gear 310 and a connecting rod portion 320, and the first gear 310 is engaged with the driving assembly 100. More specifically, the first gear is engaged with the first rotating shaft 130. One end of the connecting rod portion 320 is assembled with the first gear 310, and the other end of the connecting rod portion 320 is assembled with the hammer arm assembly 200.

More specifically, the first gear 310 includes a gear body 311 and an eccentric boss 312, wherein the eccentric boss 312 is fixedly connected to a bottom surface of the gear body 311, the gear body 311 is engaged with the first rotating shaft 130, and an outer surface of the eccentric boss 312 is sleeved with one end of the connecting rod.

It is worth mentioning that, the center of the eccentric boss 312 does not overlap the center of the gear body 311, the eccentric boss 312 revolves by taking the gear body 311 as the revolution center, and the entire eccentric boss 312 revolves following the gear body 311. Meanwhile, the first transmission assembly 300 is respectively assembled with the eccentric boss 312 and the hammer arm assembly 200, and finally, the connecting rod portion 320 reciprocates under the constraint of both the eccentric boss 312 and the hammer arm assembly 200. In this way, the connecting rod portion 320 generates an acting force in front of and behind an end of the arm body 220 in a linear direction. When the middle portion of the arm body 220 is movably assembled with a supporting rod, the arm body rotates around the supporting rod under the reciprocating pulling action of the connecting rod portion 320, and the hammer head 210 performs a reciprocating arc motion.

The connecting rod portion 320 includes a sleeve arm 321 and a connecting arm 322, wherein one end of the sleeve arm 321 is sleeved on the periphery of the eccentric boss 312, the other end of the sleeve arm 321 is assembled with one end of the connecting arm 322, and the other end of the connecting arm 322 is rotatably assembled with the hammer arm assembly 200. One end of the connecting arm 322 is provided with a ball head 323, and the ball head 323 is rotatably assembled with the hammer arm assembly 200.

It is worth mentioning that, the first transmission assembly 300 of the present invention converts the rotational motion of the driving assembly 100 into a linear back-and-forth reciprocating motion through the eccentric boss 312, thereby generating a reciprocating push-and-pull action force on the hammer arm assembly 200.

The second transmission assembly 400 includes a rotating rod 430, a spring 450, a belt pulley 420, a second bearing 440 and a transmission belt 410, wherein the belt pulley 420 is rotatably assembled on an outer surface of the rotating rod 430, and the rotating rod 430 is in transmission assembly with the hammer arm assembly 200. One end of the spring 450 is fixedly connected to the belt pulley 420, and the other end of the spring 450 is fixedly connected to the rotating rod 430. The transmission belt 410 is assembled on the second rotating shaft 140 of the driving assembly 100 and the belt pulley 420. The belt pulley 420 and the second bearing 440 are rotatably assembled on an outer surface of the rotating rod 430 from outside to inside.

It is worth mentioning that, when the driving assembly 100 rotates in one direction, the spring 450 is in a tightened state. At this point, the spring 450 propels the rotating rod 430 to rotate, and the rotating rod 430 transmits an acting force to the hammer head 210 and the arm body 220 through the eccentric wheel 240 of the hammer arm assembly 200. Subsequently, the hammer head 210 and the arm body 220 are propelled by the first transmission assembly 300 to reciprocate back and forth within the area of each sub-central angle. When the driving assembly 100 rotates in the other direction, the spring 450 is in a relaxed state. At this point, the rotating rod 430 does not rotate, and the hammer arm assembly 200 is merely propelled by the first transmission assembly 300 to perform a reciprocating arc motion.

The hammer arm assembly 200 of the present invention includes a hammer head 210, an arm body 210, an eccentric wheel 240, a first bearing 260 and a fixing member 230, wherein the hammer head 210 and the fixing member 230 are respectively fixedly assembled at two ends of the arm body 210, the eccentric wheel 240 is fixedly assembled at a tail end of the rotating rod 430, and the arm body 210 is movably assembled on the eccentric wheel 240. The fixing member 230 is provided with a spherical chamber 250, and the ball head 323 is rotatably assembled inside the spherical chamber 250.

The eccentric wheel 240 is provided with a wheel body 241 and an assembling end 242, wherein the assembling end 242 is integrally connected to the wheel body 241, and the center of the assembling end 242 does not overlap the center of the wheel body 241. The assembling end 242 is sleeved with the first bearing 260, and the wheel body 241 and the rotating rod 430 are fixedly sleeved. The arm body 210 and the eccentric wheel 240 are movably assembled through the first bearing 260, and the first bearing 260 is sleeved on an outer surface of the eccentric wheel. The center of the first bearing 260 is the center of the arc of the present invention.

When the motor 110 rotates forward, the second rotating shaft 140 rotates forward. At this point, the transmission belt 410 propels the belt pulley 420 to rotate. Due to the rotation of the belt pulley 420, the spring 450 with one end fixed on the belt pulley 420 is increasingly tightened, and finally, the tightened spring propels the rotating rod 430 to rotate. When the rotating rod 430 rotates, the eccentric wheel 240 assembled at an end of the rotating rod 430 also rotates along with the rotation of the rotating rod 430, and under the action of the eccentric wheel 240, the assembling end 242 rotates eccentrically relative to the second rotating shaft 140. At this point, under the action of both the eccentric rotation of the second rotating shaft 140 and the push-pull force of the connecting rod portion 320, the arm body 220 sleeved on the assembling end 242 propels the hammer head 210 and the arm body 220 to respectively perform a reciprocating arc motion in each sub-central angle.

Contrarily, when the motor 110 rotates reversely, the second rotating shaft 140 rotates reversely as well. At this point, the transmission belt 410 propels the belt pulley 420 to rotate, the spring 450 fixed on the belt pulley 420 is in a relaxed state, and the rotating rod 430 does not rotate. The eccentric wheel 240 assembled at an end of the connecting rod portion 320 is in a stationary state relative to the rotating rod, and the assembling end 242 of the eccentric wheel is also in a stationary state. At this point, the arm body 220 movably assembled at the assembling end 242 rotates around the stationary assembling end 242. In this state, when the connecting rod portion 320 reciprocates to push the fixing member 230 at the lower portion of the arm body 220, the arm body 220 performs a reciprocating knocking motion.

The spherical chamber 250 and the ball head 323 interact to form a joint movement. The connecting rod portion 320 performs a left-right swinging piston movement instead of a strictly linear movement, and the ball head 323 is accommodated in the spherical chamber 250, so that damage to the arm body 220 during the left-right swinging is effectively prevented.

A plurality of annular protrusions are arranged on an inner surface of the transmission belt 410, and the plurality of annular protrusions are distributed in parallel. The outer surface of the belt pulley 420 is provided with a first annular groove interacting with the annular protrusion, and the annular protrusion is embedded in the first annular groove.

It is worth mentioning that, the transmission among the annular protrusions between the second rotating shaft 140 and the belt pulley 420, the first annular groove and the second annular groove are continuous. Experiments show that the strength during the hammering process is significantly increased.

In a contrast experiment, the continuous transmission among the second rotating shaft 140, the transmission belt 410 and the belt pulley 420 is replaced by an intermittent transmission. If an outer surface of the second rotating shaft 140 is provided with a toothed structure, an inner surface of the transmission belt 410 is provided with a toothed structure, and an outer surface of the belt pulley 420 is also provided with a toothed structure, the transmission belt 410 is in meshing transmission with the second rotating shaft 140 and the belt pulley 420. In contrast experiments, the hammering strength during the process may vary.

The principle that the hammer mechanism reciprocates back and forth in areas of a plurality of sub-central angles is as follows: the arm body 210 is assembled at the assembling end 242 of the eccentric wheel 240; because the assembling end 242 is biased, when the hammer arm assembly 200 operates under the action of the second transmission assembly 400, the arm body 210 and the hammer head 210 perform a reciprocating arc motion in the area where the central angle is defined as A; at this point, the first transmission assembly 300 imposes a push-pull acting force on the hammer arm assembly 200, thereby limiting the rotation of the arm body 210 at the assembling end 242 such that the reciprocating arc motion in each sub-central angle is realized.

The operating principle of the hammering mechanism with hammering and clamping functions of the present invention is as follows: when the motor 110 rotates forward, the second rotating shaft 140 of the motor 110 propels the belt pulley 420 to rotate by means of the transmission belt 410, and the belt pulley 420 propels the spring 450 to contract; after the spring 450 is tightened and can no longer contract, the spring 450 propels the rotating rod 430 to rotate, and the rotating rod 430 propels the arm body 220 to rotate; at this point, the first rotating shaft 130 of the motor 110 propels the duplex gear 120 to rotate forward, the duplex gear 120 propels the first gear 310 to rotate, and the first gear 310 propels the connecting rod portion 320 to rotate to perform a piston motion; under the combined action of the rotating rod 430 and the connecting rod portion 320, the middle portion of the arm body 220 sequentially passes through the areas of the plurality of sub-central angles along the central axis of the rotating rod 430 and reciprocates back and forth within the area each sub-central angle; in this way, the hammer head 210 generates a clamping force;

When the motor 110 rotates reversely, the second rotating shaft 140 of the motor 110 propels the belt pulley 420 to rotate by means of the transmission belt 410, and the belt pulley 420 propels the spring 450 to relax; at this point, the rotating rod 430 does not rotate, so that the belt pulley 420 does not act on the hammer arm assembly 200; the first rotating shaft 130 of the motor 110 propels the duplex gear 120 to rotate reversely, the duplex gear 120 propels the first gear 310 to rotate, and the first gear 310 propels the connecting rod portion 320 to rotate to perform a piston motion; an tail end of the arm body 220 acts forward and backward along the linear direction, and the middle portion of the arm body 220 performs a reciprocating arc motion along the central axis of the rotating rod 430, so that the hammer head 210 generates a back-and-forth knocking force.

Moreover, according to the technical solution of the hammer mechanism of the present invention, the size and number of the sub-central angles may be adjusted through the electric control of the motor 110 and the adjustment of the eccentric boss 312 and the eccentric wheel 240. Thus, the adjustment of the clamping massage function is achieved.

According to the hammering mechanism with hammering and clamping functions of the present invention, under the combined action of the first transmission assembly 300 and the second transmission assembly 400, when the hammer arm assembly 200 entirely performs a reciprocating motion within an arc area, a hammering effect is achieved, and when the hammer arm assembly 200 reciprocates back and forth within an area of each sub-central angle, back-and-forth reciprocating motion is performed at different angles such that pressing and pushing effects on a user are achieved. In this way, when the hammer head acts on the skin of a user, the effect of reciprocatively pushing, squeezing and knocking are synchronously realized. Thus, an ideal effect of massage is achieved.

### Embodiment 2

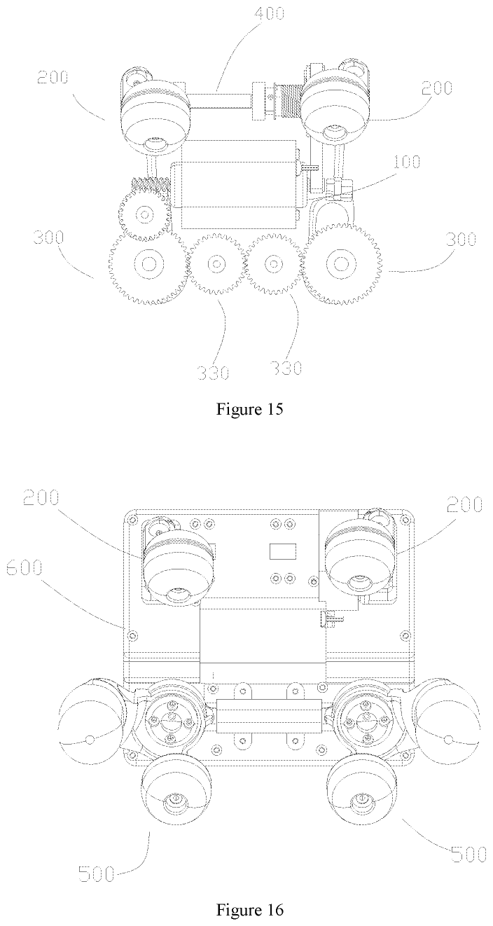

As shown in FIG. 15, except for the following features, other features of the hammering mechanism with hammering and clamping functions in embodiment 2 are the same as those in embodiment 1: there are a plurality of first transmission assemblies 300 and a plurality of hammer arm assemblies 200. In this embodiment, there are two first transmission assemblies 300 and two hammer arm assemblies 200.

The number of the first transmission assemblies 300 is the same as the number of the hammer arm assemblies 200, and the first transmission assemblies 300 correspond to the hammer arm assemblies 200 one by one. The first gears 310 of the at least one first transmission assembly 300 are engaged with the duplex gears 120.

It is worth mentioning that, in this embodiment, the plurality of first transmission assemblies 300 of the hammering mechanism with hammering and clamping functions are mutually propelled. Therefore, the plurality of first transmission assemblies 300 and the hammer arm assemblies 200 may be simultaneously propelled to move by means of the same driving assembly 100. In this way, the number of the driving assemblies 100 is significantly reduced.

### Embodiment 3

A neck massage device has a hammering mechanism with hammering and clamping functions in embodiment 1 or 2. In this embodiment, there are two first transmission assemblies 300 and two hammer arm assemblies 200.

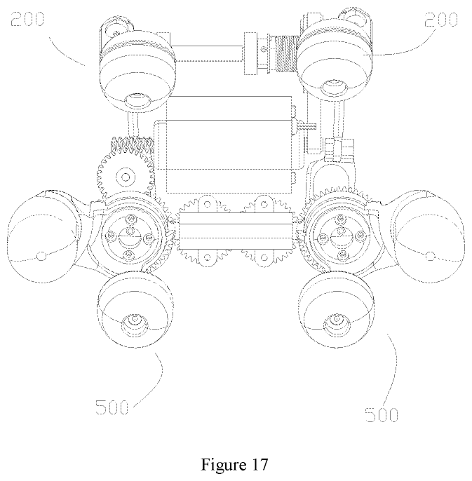

As shown in FIGS. 16 and 17, the neck massage device further includes a shell and a rotating massage mechanism 500, wherein the rotating massage mechanism 500 and the hammering mechanism with hammering and clamping functions are both assembled inside the shell 600, and the rotating massage mechanism 500 is assembled on the first gear 310 of the first transmission assembly 300.

The rotating massage mechanism of the present invention integrally rotates with the first gear 310.

It should be noted that, the hammering mechanism and the rotating massage mechanism 500 of the present invention are propelled by the same motor 11. When the motor 110 rotates forward, the hammering mechanism performs a clamping motion, and the rotating massage mechanism 500 rotates. When the hammering mechanism and the rotating massage mechanism 500 are closest to each other, a greater pressing force is generated for the user, thereby significantly improving the massage effect.

The neck massage device propels the hammer arm assembly 200 to perform a reciprocating arc motion through the piston movement of the first transmission assembly 300, thereby generating a knocking action force while achieving a hammering effect. Simultaneously, the rotating massage mechanism 500 of the hammering mechanism with hammering and clamping functions performs a rotational motion such that a rotating massage effect is realized. The neck massage device possesses a rotating massage function and a hammering massage function, achieving an ideal massage effect on the user's shoulder and neck.

It should be noted that the above embodiments are merely used to illustrate the technical solution of the present invention rather than limit the scope of the present invention. Although the present invention has been described in detail with reference to preferred embodiments, it should be understood by those skilled in the art that modifications or equivalent replacements may be made to the technical solution of the present invention without departing from the spirit and scope of the technical solution of the present invention.

What is claimed is:

1. A hammering mechanism with hammering and clamping functions, comprising:
a driving assembly,
a hammer arm assembly,
a first transmission assembly for converting a rotational motion generated by the driving assembly into a piston motion, and
a second transmission assembly for transmitting the rotational motion generated by the driving assembly to the hammer arm assembly,
wherein both the first transmission assembly and the second transmission assembly are in transmission connection with the driving assembly, and both the first transmission assembly and the second transmission assembly are in transmission connection with the hammer arm assembly, wherein when the first transmission assembly operates individually, the hammer arm assembly performs a reciprocating arc motion, wherein a central angle of an arc is defined as a total central angle, wherein the total central angle is divided into a plurality of sub-central angles, wherein when the first transmission assembly and the second transmission assembly operate together, the hammer arm assembly sequentially passes through areas of the plurality of sub-central angles and reciprocates in the area of each sub-central angle of the plurality of sub-central angles.

2. The hammering mechanism with the hammering and clamping functions of claim 1, wherein the second transmission assembly comprises:
a rotating rod, a spring and a belt pulley, wherein the belt pulley is rotatably assembled on an outer surface of the rotating rod, wherein a first end of the spring is fixedly connected to the belt pulley, and a second end of the spring is fixedly connected to the rotating rod, wherein the rotating rod is in transmission assembly with the hammer arm assembly,
wherein the hammer arm assembly comprises:
a hammer head, an arm body, a fixing member and an eccentric wheel, wherein the hammer head and the fixing member are respectively fixedly assembled at two ends of the arm body, the eccentric wheel is fixedly assembled at a tail end of the rotating rod, and the arm body is movably assembled on the eccentric wheel, wherein the first transmission assembly is movably assembled with the fixing member, and the driving assembly is assembled with the belt pulley in a transmission mode through a belt.

3. The hammering mechanism with the hammering and clamping functions of claim 2, wherein the eccentric wheel is provided with a wheel body and an assembling end, wherein the assembling end is eccentric relative to the rotating rod, and the arm body is movably assembled with the assembling end.

4. The hammering mechanism with the hammering and clamping functions of claim 2, wherein the arm body and the eccentric wheel are movably assembled through a first bearing, and a center of the first bearing is the center of the arc.

5. The hammering mechanism with the hammering and clamping functions of claim 1, wherein the first transmission assembly comprises a first gear and a connecting rod portion, and the first gear is engaged with the driving assembly, wherein a first end of the connecting rod portion is assembled with the first gear, and a second end of the connecting rod portion is assembled with the hammer arm assembly;
wherein the first gear comprises:
a gear body and an eccentric boss, wherein the eccentric boss is fixedly connected to a side of the gear body;
wherein the connecting rod portion comprises:
a sleeve arm and a connecting arm, wherein the gear body is engaged with the driving assembly, wherein a first end of the sleeve arm is sleeved on a periphery of the eccentric boss, and a second end of the sleeve arm is assembled with a first end of the connecting arm, wherein a ball head arranged on a second end of the connecting arm is rotatably assembled with a fixing member of the hammer arm assembly.

6. The hammering mechanism with the hammering and clamping functions of claim 5, wherein the fixing member is provided with a spherical chamber, and the ball head is rotatably assembled inside the spherical chamber.

7. The hammering mechanism with the hammering and clamping functions of claim 6, wherein the driving assembly comprises:
a motor and a duplex gear, wherein a first rotating shaft of the motor is engaged with a first layer of the duplex gear, a second rotating shaft of the motor is in transmission connection with a transmission belt, and a second layer of the duplex gear is engaged with the first gear;
wherein when the transmission belt propels a belt pulley to rotate, the belt pulley propels a spring to tighten, wherein at this point, the second rotating shaft rotates forward, and meanwhile, the spring propels a rotating rod to rotate; and
wherein the belt pulley is propelled by the transmission belt to rotate, and the belt pulley does not propel the spring to tighten, wherein at this point, the second rotating shaft rotate reversely, and the rotating rod does not rotate along with a rotation of the transmission belt.

8. The hammering mechanism with the hammering and clamping functions of claim 7, wherein a plurality of annular protrusions are arranged on an inner surface of the transmission belt, and the plurality of annular protrusions are distributed in parallel, wherein an outer surface of the belt pulley is provided with a first annular groove for interacting with an annular protrusion of the plurality of annular protrusions, wherein the annular protrusion is embedded in the first annular groove, wherein an outer surface of the first rotating shaft is provided with threads for interacting with the first gear, wherein an outer surface of the second rotating shaft is provided with a plurality of second annular grooves for interacting with the plurality of annular protrusions, and the plurality of annular protrusions are embedded in the plurality of second annular grooves.

9. The hammering mechanism with the hammering and clamping functions of claim 1, comprising a plurality of first transmission and a plurality of hammer arm assemblies, wherein a number of the plurality of first transmission assemblies is same as a number of the plurality of hammer arm assemblies, and the plurality of first transmission assemblies correspond to the plurality of hammer arm assemblies one by one, wherein first gears of at least one first transmission assembly of the plurality of first transmission assemblies are engaged with duplex gears, wherein each first transmission assembly of the plurality of first transmission assemblies is further provided with a second gear, the second gear is engaged with the first gear of the same first transmission assembly, and the second gear is further engaged with a second gear of an adjacent first transmission assembly.

10. A neck massage device having the hammering mechanism with the hammering and clamping functions of claim 1, wherein the neck massage device further comprises:
a shell and a rotating massage mechanism, wherein the rotating massage mechanism and the hammering mechanism with hammering and clamping functions are assembled inside the shell, and the rotating massage mechanism is assembled on the first gear of the first transmission assembly.

11. The hammering mechanism with the hammering and clamping functions of claim 3, wherein the arm body and the eccentric wheel are movably assembled through a first bearing, and a center of the first bearing is the center of the arc.

12. The hammering mechanism with the hammering and clamping functions of claim 2, wherein the first transmission assembly comprises a first gear and a connecting rod portion, and the first gear is engaged with the driving assembly, wherein a first end of the connecting rod portion is assembled with the first gear, and a second end of the connecting rod portion is assembled with the hammer arm assembly;
wherein the first gear comprises:
a gear body and an eccentric boss, wherein the eccentric boss is fixedly connected to a side of the gear body;
wherein the connecting rod portion comprises:
a sleeve arm and a connecting arm, wherein the gear body is engaged with the driving assembly, wherein a first end of the sleeve arm is sleeved on a periphery of the eccentric boss, and a second end of the sleeve arm is assembled with a first end of the connecting arm, wherein a ball head arranged on a second end of the connecting arm is rotatably assembled with a fixing member of the hammer arm assembly.

13. The hammering mechanism with the hammering and clamping functions of claim 3, wherein the first transmission assembly comprises a first gear and a connecting rod portion, and the first gear is engaged with the driving assembly, wherein a first end of the connecting rod portion is assembled with the first gear, and a second end of the connecting rod portion is assembled with the hammer arm assembly;
wherein the first gear comprises:
a gear body and an eccentric boss, wherein the eccentric boss is fixedly connected to a side of the gear body;
wherein the connecting rod portion comprises:
a sleeve arm and a connecting arm, wherein the gear body is engaged with the driving assembly, wherein a first end of the sleeve arm is sleeved on a periphery of the eccentric boss, and a second end of the sleeve arm is assembled with a first end of the connecting arm, wherein a ball head arranged on a second end of the connecting arm is rotatably assembled with a fixing member of the hammer arm assembly.

14. The hammering mechanism with the hammering and clamping functions of claim 2, comprising a plurality of first transmission assemblies and a plurality of hammer arm assemblies, wherein a number of the plurality of first transmission assemblies is same as a number of the plurality of hammer arm assemblies, and the plurality of first transmission assemblies correspond to the plurality of hammer arm assemblies one by one, wherein first gears of at least one first transmission assembly of the plurality of first transmission assemblies are engaged with duplex gears, wherein each first transmission assembly of the plurality of first transmission assemblies is further provided with a second gear, the second gear is engaged with the first gear of the same first transmission assembly, and the second gear is further engaged with a second gear of an adjacent first transmission assembly.

15. The hammering mechanism with the hammering and clamping functions of claim 3, comprising a plurality of first transmission assemblies and a plurality of hammer arm assemblies, wherein a number of the plurality of first transmission assemblies is same as a number of the plurality of hammer arm assemblies, and the plurality of first transmission assemblies correspond to the plurality of hammer arm assemblies one by one, wherein first gears of at least one first transmission assembly of the plurality of first transmission assemblies are engaged with duplex gears, wherein each first transmission assembly of the plurality of first transmission assemblies is further provided with a second gear, the second gear is engaged with the first gear of the same first transmission assembly, and the second gear is further engaged with a second gear of an adjacent first transmission assembly.

16. The hammering mechanism with the hammering and clamping functions of claim 4, comprising a plurality of first transmission assemblies and a plurality of hammer arm assemblies, wherein a number of the plurality of first transmission assemblies is same as a number of the plurality of hammer arm assemblies, and the plurality of first transmission assemblies correspond to the plurality of hammer arm assemblies one by one, wherein first gears of at least one first transmission assembly of the plurality of first transmission assemblies are engaged with duplex gears, wherein each first transmission assembly of the plurality of first transmission assemblies is further provided with a second gear, the second gear is engaged with the first gear of the same first transmission assembly, and the second gear is further engaged with a second gear of an adjacent first transmission assembly.

17. The hammering mechanism with the hammering and clamping functions of claim 5, comprising a plurality of first transmission assemblies and a plurality of hammer arm assemblies, wherein a number of the plurality of first transmission assemblies is same as a number of the plurality of hammer arm assemblies, and the plurality of first transmission assemblies correspond to the plurality of hammer arm assemblies one by one, wherein first gears of at least one first transmission assembly of the plurality of first transmission assemblies are engaged with duplex gears, wherein each first transmission assembly of the plurality of first transmission assemblies is further provided with a second gear, the second gear is engaged with the first gear of the same first transmission assembly, and the second gear is further engaged with a second gear of an adjacent first transmission assembly.

18. The hammering mechanism with the hammering and clamping functions of claim 6, comprising a plurality of first transmission assemblies and a plurality of hammer arm assemblies, wherein a number of the plurality of first transmission assemblies is same as a number of the plurality of hammer arm assemblies, and the plurality of first transmission assemblies correspond to the plurality of hammer arm assemblies one by one, wherein first gears of at least one first transmission assembly of the plurality of first transmission assemblies are engaged with duplex gears, wherein each first transmission assembly of the plurality of first transmission assemblies is further provided with a second gear, the second gear is engaged with the first gear of the same first transmission assembly, and the second gear is further engaged with a second gear of an adjacent first transmission assembly.

19. The hammering mechanism with the hammering and clamping functions of claim 7, comprising a plurality of first transmission assemblies and a plurality of hammer arm assemblies, wherein a number of the plurality of first transmission assemblies is same as a number of the plurality of hammer arm assemblies, and the plurality of first transmission assemblies correspond to the plurality of hammer arm assemblies one by one, wherein first gears of at least one first transmission assembly of the plurality of first transmission assemblies are engaged with duplex gears, wherein each first transmission assembly of the plurality of first transmission assemblies is further provided with a second gear, the second gear is engaged with the first gear of the same first transmission assembly, and the second gear is further engaged with a second gear of an adjacent first transmission assembly.

20. The hammering mechanism with the hammering and clamping functions of claim 8, comprising a plurality of first transmission assemblies and a plurality of hammer arm assemblies, wherein a number of the plurality of first transmission assemblies is same as a number of the plurality of hammer arm assemblies, and the plurality of first transmission assemblies correspond to the plurality of hammer arm assemblies one by one, wherein first gears of at least one first transmission assembly of the plurality of first transmission assemblies are engaged with duplex gears, wherein each first transmission assembly of the plurality of first transmission assemblies is further provided with a second gear, the second gear is engaged with the first gear of the same first transmission assembly, and the second gear is further engaged with a second gear of an adjacent first transmission assembly.
